(19) United States
(12) Patent Application Publication
(10) Pub. No.: US 2007/0040790 A1
(43) Pub. Date: Feb. 22, 2007

(54) Residual image improving system for liquid crystal display

(75) Inventors: Cheng-Liang Hsiao, Miao-Li (TW); An Shih, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/507,286

(22) Filed: Aug. 21, 2006

(30) Foreign Application Priority Data
Aug. 19, 2005 (TW) 94128499

(51) Int. Cl. G09G 3/36

(52) U.S. Cl. 345/98

(57) ABSTRACT

An exemplary residual image improving system (100) for an LCD includes an LCD panel, a gate driver, data driver, a video and timing control unit (12), a DC power supply (13), an power input terminal (V_{CC}), and a current limiting resistor (R). The power input terminal receives operating power from an external power supply, and provides the operating power to the gate driver, the video and timing control unit, and the DC power supply. The video and timing control is connected to the power input terminal, and provides image signals and a timing signal to the data driver and the gate driver respectively. The DC power supply is connected to the power input terminal, and provides electric potential to the gate driver and the data driver. The data driver provides gray scale voltages to the LCD panel. The current limiting resistor is connected between the power input terminal and ground.

### FIELD OF THE INVENTION

This invention relates to a residual image improving system for a liquid crystal display (LCD), the system including a current limiting resistor.

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

Usually, an LCD needs an external power supply for providing operating power. When the LCD operates, much electric charge is stored therein. When the LCD is powered off, electric charge stored therein is not discharged quickly. This makes the voltage at the external power supply connection drop slowly. As a result, a gate driver and a data driver that drive the LCD operate incorrectly, thereby producing a residual image on the LCD.

FIG. 3 is a schematic diagram of a typical residual image improving system for an LCD. The residual image improving system 200 includes a power input terminal V_{CC}, a voltage detector 1, a video and timing control unit 2, a direct current power supply 3, a gate driver 42, a data driver 41, and an LCD panel 43. The power input terminal V_{CC} obtains operating power from an external power supply (not shown), and provides the operating power to the voltage detector 1, the video and timing control unit 2, and the direct current power supply 3 respectively.

The direct current power supply 3 receives the operating power from the power input terminal V_{CC}, and provides electric potential to the gate driver 42 and the data driver 41. The video and timing control unit 2 receives image signals Sᵥ, Sᵣ from an external circuit (not shown), and provides the image signals Sᵥ, Sᵣ to the data driver 41. The video and timing control unit 2 also provides a timing signal to the gate driver 42. The gate driver 42 generates a plurality of scan signals according to the timing signal and the electric potential, and scans the LCD panel 43 with the scan signals. The data driver 41 generates a plurality of gray scale voltages according to the image signals Sᵥ, Sᵣ and the electric potential, and provides the gray scale voltages to the LCD panel 43 when the LCD panel 43 is scanned.

The voltage detector 1 is configured with a threshold voltage, which is set to a level slightly higher than a power-off voltage level of the direct current power supply 3. Thus the residual image improving system 200 can be powered by the direct current power supply 3 for a period of time, even if the external power (not shown) is turned off. For example, when the external power supply and the power-off voltage level of the direct current power supply 3 are respectively equal to 3.3 volts and 2.5 volts, the threshold voltage of the voltage detector 1 can be set to 2.8 volts.

When the residual image improving system 200 is powered off, the 3.3 volt external power supply inputted to the voltage detector 1 is decreased to a value between the 2.8 volt threshold voltage and the 2.5 volt power-off voltage. Thus, the voltage detector 1 outputs a switching control signal S_{C} to the video and timing control unit 2 according to the 2.8 volt threshold voltage. The video and timing control unit 2 selects a predetermined image according to the switching control signal Sc, and outputs signals corresponding to the predetermined image to the gate driver 42 and the data driver 41. Then the LCD panel 43 displays the predetermined image accordingly. The displayed predetermined image is configured to prevent the visual system of a human being from being influenced by any residual image effect.

However, the voltage detector 1 is generally expensive, and the cost of the residual image improving system 100 is correspondingly high.

What is needed, therefore, is a residual image improving system for an LCD that overcomes the above-described deficiencies.

### SUMMARY

In a preferred embodiment, a residual image improving system for an LCD includes an LCD panel, a gate driver, data driver, a video and timing control unit, a direct current power supply, an power input terminal, and a current limiting resistor. The power input terminal receives operating power from an external power supply, and provides the operating power to the gate driver, the video and timing control unit, and the direct current power supply. The video and timing control is connected to the power input terminal, and provides image signals and a timing signal to the data driver and gate driver respectively. The direct current power supply is connected to the power input terminal, and provides electric potential to the gate driver and data driver respectively. The current limiting resistor is connected between the power input terminal and ground. The data driver provides gray scale voltages to the LCD panel when the LCD panel is scanned by the gate driver.

Other advantages and novel features will become more apparent from the following detailed description when taken in conjunction with the accompanying drawings.

### BRIEF DESCRIPTION OF THE DRAWINGS

FIG. 1 is a schematic diagram of a residual image improving system for an LCD according to a preferred embodiment of the present invention.

FIG. 2 is an equivalent circuit diagram of the residual image improving system of FIG. 1 when the system is powered off.

FIG. 3 is a schematic diagram of a conventional residual image improving system for an LCD.

### DETAILED DESCRIPTION OF PREFERRED EMBODIMENTS

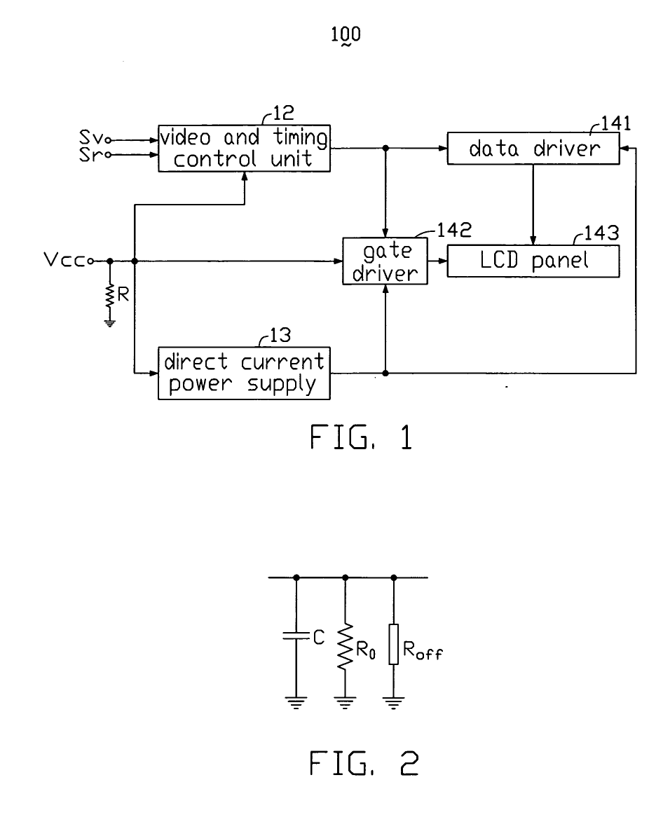

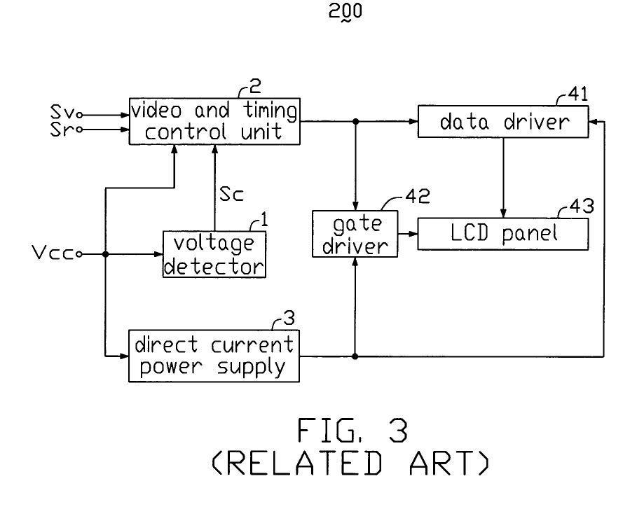

FIG. 1 is a schematic diagram of a residual image improving system for an LCD according to a preferred embodiment of the present invention. The residual image improving system 100 includes an power input terminal V_{CC} connected to an external power supply (not shown), a video and timing control unit 12 connected to the power input terminal V_{CC}, a direct current power supply 13 connected to the power input terminal V_{CC}, a gate driver 142 connected to the power input terminal V_{CC}, a data driver 141, an LCD panel 143, and a current limiting resistor “R” connected between the power input terminal V_{CC} and ground. A resistance of the current limiting resistor “R” is 100Ω.

The external power supply (not shown) provides operating power via the power input terminal V_{CC} to the video and timing control unit 12, the direct current power supply 13, and the gate driver 142 respectively. The direct current power supply 13 provides electric potential to the gate driver 142 and the data driver 141 respectively. The video and timing control unit 12 receives image signals Sᵥ, Sᵣ from an external circuit (not shown), and provides the image signals Sᵥ, Sᵣ to the data driver 141. The video and timing control unit 12 also provides a timing signal to the gate driver 142. The gate driver 142 generates a plurality of scan signals according to the timing signal and the electric potential, and scans the LCD panel 143 with the scan signals. The data driver 141 generates a plurality of gray scale voltages according to the image signals Sᵥ, Sᵣ and the electric potential, and provides the gray scale voltages to the LCD panel 143 when the LCD panel 143 is scanned. When the residual image improving system 100 is powered off, electric charge stored in the residual image improving system 100 can be quickly discharged via the current limiting resistor “R”.

FIG. 2 is an equivalent circuit diagram of the residual image improving system 100 when it is powered off. The external power supply (not shown) having much electric charge can be regarded as a capacitor “C”. A time parameter “T” in which the capacitor “C” is discharged to zero volts (0V) is calculated according to the following equations:

$$T = \frac{{R}_{1} \cdot C}{0.434} log [ \frac{ɛ}{V} ]$$

$$\frac{1}{{R}_{1}} = \frac{1}{{R}_{0}} + \frac{1}{{R}_{off}}$$

“V” represents a voltage applied to the capacitor “C”. “ε” represents a constant. R_{off} represents an inner impedance of the external power supply. R₀ represents a resistance of the current limiting resistor “R”. A value of R₀ is typically much smaller than that of R_{off}.

According to the above equations, and supposing there is no current limiting resistor “R”, then in the second equation, R₁ is equal to R_{off}. Typically, the value of R_{off} is very large. Thus the value of R₁ is very large. Then in the first equation, the discharge time “T” is essentially only determined by the value of R₁. That is, the discharge time “T” is essentially only determined by the value of R_{off}. Further, because the value of R_{off} is typically very large, the discharge time “T” is also correspondingly large. Because the capacitor “C” is discharged to zero volts slowly, the voltage of the external power supply at the power input terminal V_{CC} drops slowly. During this time, the residual image improving system 100 can still be powered by the direct current power supply 13 for a period of time. Thus the gate driver 142 and the data driver 141 driving the LCD panel 143 can operate incorrectly, and thereby a residual image is produced on the LCD panel 143.

The above-described supposition is in marked contrast to the preferred embodiment herein. In the preferred embodiment, the current limiting resistor “R” is connected between the power input terminal V_{CC} and ground. Therefore the inner impedance of the external power supply (R_{off}) is connected in parallel with the current limiting resistor “R”. Because a value of R₀ is much smaller than that of R_{off}, then in the second equation, R₁ is approximately equal to R₀. Further, because the value of R₀ is typically very small, the value of R₁ is correspondingly very small. Then in the first equation, the discharge time “T” is also correspondingly small. That is, the discharge time “T” can be substantially decreased in order to reduce or even eliminate the residual image effect.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A residual image improving system for a liquid crystal display (LCD), comprising:
a power input terminal for receiving operating power from an external power supply;
an LCD panel;
a gate driver connected to the power input terminal and being configured to scan the LCD panel;
a data driver configured to provide gray scale voltages to the LCD panel;
a video and timing control unit connected to the power input terminal, the video and timing control unit configured to provide image signals and a timing signal to the data driver and gate driver respectively;
a direct current power supply connected to the power input terminal, the direct current power supply configured to provide electric potential to the gate driver and data driver respectively; and
a current limiting resistor configured to be connected between the power input terminal and ground.

2. The residual image improving system as claimed in claim 1, wherein an inner resistance of the external power supply is larger than a resistance of the current limiting resistor.

3. The residual image improving system as claimed in claim 1, wherein the resistance of the current limiting resistor is approximately equal to 100Ω.

4. The residual image improving system as claimed in claim 1, wherein the gate driver generates a plurality of scan signals according to the timing signal and the electric potential, and scans the LCD panel with the scan signals.

5. The residual image improving system as claimed in claim 1, wherein the data driver generates a plurality of gray scale voltages according to the image signals and the electric potential.

6. A residual image improving system for a liquid crystal display (LCD), comprising:
a power input terminal for receiving operating power from an external power supply;
an LCD panel;
a gate driver connected to and between the power input terminal and the LCD panel;
a data driver configured to provide gray scale voltages to the LCD panel;
a video and timing control unit respectively connected to the power input terminal, the data driver and the gate driver;
a direct current power supply connected to the power input terminal, the gate driver and data driver, respectively; and
a current limiting resistor configured to be connected between the power input terminal and ground; wherein
said resistor is linked to a joint point of a common path which is a portion of transmission paths defined between the power input terminal and the gate driver, the video and timing control unit, and direct current power supply.

7. The system as claimed in claim 6, wherein said resistor is not a part of said common path.

8. A residual image improving system for a liquid crystal display (LCD), comprising:
a power input terminal for receiving operating power from an external power supply;
an LCD panel;
a gate driver directly connected to and between the power input terminal and the LCD panel;
a data driver configured to provide gray scale voltages to the LCD panel;
a video and timing control unit respectively connected to the power input terminal, the data driver and the gate driver; and
a direct current power supply connected to the power input terminal, the gate driver and data driver, respectively.

9. The system as claimed in claim 8, wherein no specific electronic component is located on a transmission path defined between the gate driver and the power input terminal.

10. The system as claimed in claim 9, wherein a limiting resistor is linked to a joint point on a said transmission path, and grounded.

11. The system as claimed in claim 9, wherein another transmission path is defined between said video and timing control unit and the power input terminal, and a limiting resistor is linked to a joint point which is located on both said transmission path and said another transmission path, and grounded.
